(19) United States
(12) Patent Application Publication
(10) Pub. No.: US 2026/0246572 A1
(43) Pub. Date: Aug. 20, 2026

(54) HYBRID AUTOMATIC REPEAT REQUEST FEEDBACK DISABLING FOR MULTIPLE TRANSPORT BLOCK SCHEDULING

(71) Applicant: Nokia Technologies Oy, Espoo (FI)

(72) Inventors: Jing Yuan SUN, Beijing (CN); Tzu-Chung HSIEH, Naperville, IL (US); Ping Ping WEN, Shanghai (CN); Ping YUAN, Beijing (CN)

(21) Appl. No.: 19/153,793

(22) PCT Filed: Feb. 16, 2023
(86) PCT No.: PCT/CN2023/076577

§ 371 Date: Aug. 5, 2025

(51) Int. Cl. H04L 1/1829; H04L 1/1812

(52) U.S. Cl. CPC H04L 1/1854; H04L 1/1812

(57) ABSTRACT

Various example embodiments relate to methods and apparatuses for HARQ feedback disabling for multiple transport block scheduling. An apparatus may be configured to receive from a network device, first information indicating a first number of HARQ processes out of a second number of HARQ processes are configured as feedback enabled or disabled for multiple transport blocks scheduled by one control message; and receive from the network device, the multiple transport blocks.

### TECHNICAL FIELD

Various example embodiments described herein generally relate to communication technologies, and more particularly, to methods and apparatuses for Hybrid Automatic Repeat Request (HARQ) feedback disabling for multiple transport block scheduling.

### BACKGROUND

Certain abbreviations that may be found in the description and/or in the figures are herewith defined as follows:
DCI Downlink Control Information
eMTC enhanced Machine-Type Communication
HARQ Hybrid Automatic Repeat Request
IoT Internet of Things
MAC Medium Access Control
NB-IoT Narrow Band Internet of Things
NR New Radio
NTN Non-Terrestrial Network
PDCCH Physical Downlink Control Channel
RRC Radio Resource Control
TB Transport Block
UE User Equipment

Third Generation partnership project, 3GPP has developed support for Internet of Things (IoT), including for example Narrow Band Internet of Things (NB-IoT) and enhanced Machine-Type Communication (eMTC), over a Non-Terrestrial Network (NTN) where an NTN node may be deployed to communicate with user equipments (UEs) on the ground. The NTN node may be implemented as a radio repeater to relay communications between UEs and base stations on the ground, or it may include a base station onboard. The NTN can extend IoT services to remote places without terrestrial infrastructures.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, an example embodiment of a terminal device is provided. The terminal device may comprise at least one processor and at least one memory. The at least one memory may store instructions that, when executed by the at least one processor, cause the terminal device at least to receive from a network device, first information indicating a first number of hybrid automatic repeat request (HARQ) processes out of a second number of HARQ processes are configured as feedback enabled or disabled for multiple transport blocks scheduled by one control message, and receive from the network device, the multiple transport blocks. The second number may be less than or equal to the number of the multiple transport blocks

In a second aspect, an example embodiment of a network device is provided. The access network device may comprise at least one processor and at least one memory. The at least one memory may store instructions that, when executed by the at least one processor, cause the network device at least to transmit to a terminal device, first information indicating a first number of hybrid automatic repeat request (HARQ) processes out of a second number of HARQ processes are configured as feedback enabled or disabled for multiple transport blocks scheduled by one control message, and transmit to the terminal device, the multiple transport blocks. The second number may be less than or equal to the number of the multiple transport blocks.

Example embodiments of methods, apparatus and computer program products are also provided. Such example embodiments generally correspond to the example embodiments in the above aspects and a repetitive description thereof is omitted here for convenience.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 is a schematic diagram illustrating an example communication network in which example embodiments of the present disclosure may be implemented.

FIGS. 2A and 2B are schematic diagrams illustrating scheduling of multiple transport blocks by one DCI.

FIG. 3 is a message flow diagram illustrating a process for enabling or disabling feedback for HARQ processes according to an example embodiment of the present disclosure.

FIG. 4 is a message flow diagram illustrating a process for enabling or disabling feedback for HARQ processes according to an example embodiment of the present disclosure.

FIG. 5 is a flow diagram illustrating a process for dynamically enabling or disabling feedback for HARQ processes according to an example embodiment of the present disclosure.

FIG. 6 is a flowchart illustrating operations for HARQ feedback enabling/disabling implemented at a terminal device according to an example embodiment of the present disclosure.

FIG. 7 is a flowchart illustrating operations for HARQ feedback enabling/disabling implemented at a network device according to an example embodiment of the present disclosure.

FIG. 8 is a block diagram illustrating an apparatus in accordance with an example embodiment of the present disclosure.

FIG. 9 is a block diagram illustrating an apparatus in accordance with an example embodiment of the present disclosure.

FIG. 10 is a block diagram illustrating devices in a communication system in accordance with an example embodiment of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

As used herein, the term “network device” may refer to a radio access network (RAN) device. The RAN device may include for example a base station that can provide cells or coverage, through which terminal devices can access the network or receive services. The base station may be implemented as an evolved node B (eNB), a next generation eNB (ng-eNB), a next generation node B (gNB), or a beyond 5G base station. The base station may be embodied as a macro base station, a relay node, or a low power node such as a pico base station or a femto base station. The base station may consist of several distributed network units, such as a central unit (CU), one or more distributed units (DUs), one or more remote radio heads (RRHs) or remote radio units (RRUs). The number and functions of these distributed units depend on the selected split RAN architecture. The base station may be deployed on the ground or in the sky, for example on a satellite, a high altitude platform station, an unmanned aircraft system, a balloon, an airplane, and/or the like.

As used herein, the term “terminal device” or “user equipment” (UE) may refer to any entities or devices that can wirelessly communicate with the network devices or with each other. Examples of the terminal device can include a mobile phone, a mobile terminal (MT), a mobile station (MS), a subscriber station (SS), a portable subscriber station (PSS), an access terminal (AT), a computer, a wearable device, an on-vehicle communication device, a machine type communication (MTC) device, a D2D communication device, a V2X communication device, a sensor and the like. The term “terminal device” can be used interchangeably with a UE, a user terminal, a mobile terminal, a mobile station, or a wireless device.

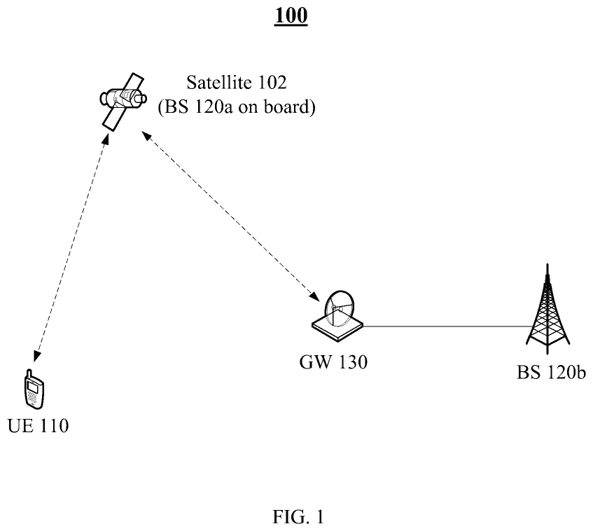

FIG. 1 is a schematic diagram illustrating an example communication network 100 in which example embodiments of the present disclosure may be implemented. The communication network 100 may form a part of a larger network e.g. a cellular communication network. Referring to FIG. 1, the communication network 100 may be implemented as a non-terrestrial network (NTN) including one or more user equipments (UEs) 110 (one is shown in FIG. 1) and one or more NTN nodes e.g., satellites 102 (one is shown in FIG. 1). The satellites 102 may include for example low Earth orbit (LEO) satellites, geostationary earth orbit (GEO) satellites, and satellites in between GEO and LEO altitudes, or it may be replaced by e.g. an airplane, a balloon, a high altitude platform station, an unmanned aircraft system, etc.

The satellites 102 may be implemented as a regenerative satellite or a transparent satellite. The regenerative satellite may include at least part of a base station 120a to perform at least part of functionalities of the base station 120a. For example, if the satellite 102 includes a 5G New Radio (NR) base station 120 a named gNB onboard, NR-Uu radio interface may be implemented on a service link between the satellite 102 and the UEs 110, and N2/N3 interface may be implemented on a feeder link between the satellite 102 and a gateway 130 on the ground. The gateway 130 may provide interconnections to terrestrial infrastructures including for example a base station 120b and/or a core network (not shown). The transparent satellite acts as an analogue radio frequency repeater to relay communications between the UEs 110 and the base station 120b on the ground (via the gateway 130). For example, if the base station 120b is implemented as a 5G NR base station named gNB, the transparent satellite may simply repeat NR-Uu radio interface on the feeder link and the service link. Additionally, the satellites 102 may also communicate with each other via an inter satellite link (ISL). With the satellites 102, the NTN 100 can extend network services to places without any terrestrial infrastructures.

As discussed above, in the NTN 100, the UEs 110 may communicate with the base station 120a deployed on the satellite 102 or the base station 120b deployed on the ground. For convenience of description, the base station 120a and the base station 120b may be collectively referred to as base stations 120 or individually as base station 120.

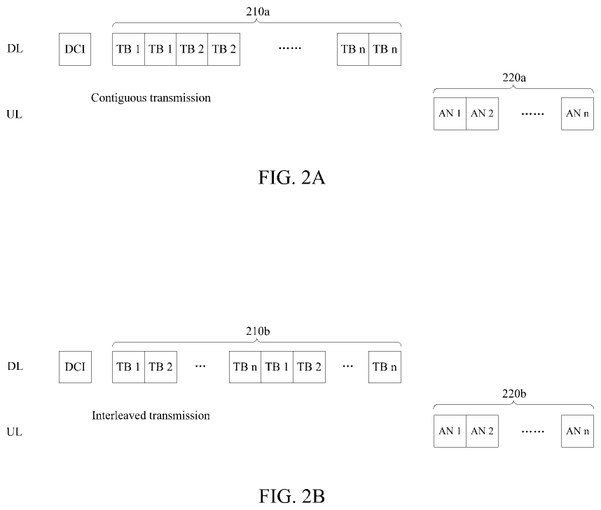

FIGS. 2A and 2B are schematic diagrams illustrating scheduling of multiple transport blocks by one downlink control information (DCI). Referring to FIG. 2A, in an Internet of Things (IoT) communication system, for example, the base station may use one DCI message to schedule downlink or uplink transmissions in multiple transport blocks 210a (e.g., TB 1, TB 2, up to TB n) for the UE. For example, in a unicast transmission mode, up to 8 TBs for enhanced Machine-Type Communication (eMTC), or up to 2 TBs for Narrow Band Internet of Things (NB-IoT) may be scheduled with one DCI. In a multicast transmission mode, up to 8 TBs for the eMTC and NB-IoT may be scheduled with one DCI. Scheduling the multiple transport blocks in a single DCI message may reduce the overhead on the control channel that the DCI is transmitted over. In order to increase the likelihood that the data is successfully received, each scheduled transport block may be repeatedly transmitted for several times, e.g., 2 or 4 times. The multiple transport blocks may be transmitted consecutively. Alternatively, referring to FIG. 2B, the multiple transport blocks may be transmitted in an interleaved way. Each transport block may be related to one separate Hybrid Automatic Repeat Request (HARQ) process. As shown in FIGS. 2A and 2B, an ACK/NACK message 220a, 220b (e.g., AN 1, AN 2, up to AN n) is transmitted for each transport blocks.

Further, 3GPP has agreed to support IoT, e.g., NB-IoT and eMTC, over the non-terrestrial network (NTN). Similar to the NR NTN, a HARQ mechanism is also used in the IoT NTN to enhance communication reliability. However, in the NTN system, a propagation delay may be significant since the distance between the base station 120 and the UE 110 is quite long, and thus the round trip time (RTT) may be relatively large, which can be up to hundreds of milliseconds. In some cases, due to the significant propagation delay in the NTN system, it may be desirable to disable HARQ feedback so as to avoid the throughput reduction due to HARQ stalling.

Considering each DCI may schedule different HARQ processes for the multiple transport blocks (TBs), it is not optimal to always disable or enable the HARQ feedback for multiple HARQ process based on semi-static RRC configuration. Additionally, different TBs may carry different data or control signaling, which may be dynamically generated and may be mapped dynamically to different HARQ process according to the available HARQ processes not in-use for other data or control signaling transmission. Different data or control signaling may have different QoS requirements. Generally, the control signaling, e.g., RRC or MAC signaling will have higher level requirement on reliability or latency. However, a semi-static configuration is not able to ensure such requirement.

Therefore, it is desirable to provide an efficient mechanism to configure the enabling and/or disabling of HARQ feedback for multiple TBs scheduled by one DCI in a dynamic way.

Hereinafter, example embodiments of methods and apparatuses supporting dynamic enabling or disabling of HARQ feedback for multiple TBs would be described in detail with reference to the drawings. The example embodiments allow a network to enable or disable feedback for HARQ processes scheduled in one DCI efficiently and adaptively. Thus, the HARQ performance can be improved. The example embodiments may be applied to IoT over NTN including eMTC NTN and NB-IoT NTN, and to NR over NTN or Redcap over NTN where multiple TBs are scheduled in one DCI.

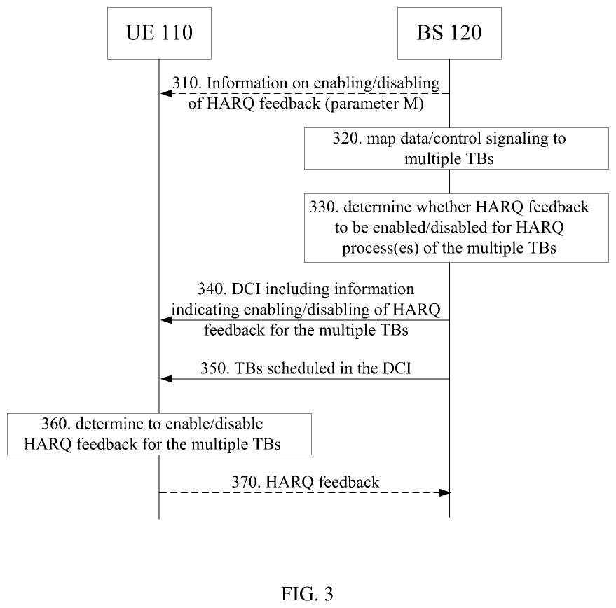

FIG. 3 is a message flow diagram illustrating a process for enabling or disabling feedback for HARQ processes according to an example embodiment of the present disclosure. The process shown in FIG. 3 may be performed by a base station and a user equipment. For example, the UE 110 and the base station 120 in the non-terrestrial communication network 100 described above with reference to FIG. 1 may be configured to perform the process of enabling or disabling of HARQ feedback. The UE 110 and the base stations 120 each may include a plurality of components, modules, means or elements to perform operations discussed below, and the components, modules, means and elements may be implemented in various manners including but not limited to for example software, hardware, firmware or any combination thereof to perform the operations.

Referring to FIG. 3, at an operation 310, the base station 120 may transmit configuration information on enabling/disabling of HARQ feedback to the UE 110. For example, the base station 120 may semi-statically configure HARQ process as feedback enabled or disable for the UE 110, e.g., via an RRC message. The configuration may indicate whether HARQ feedback is to be enabled or disabled, or which one or more HARQ processes for multiple transport blocks (TBs) are configured as HARQ feedback enabled or disabled.

In an example, the base station 120 may further configure, for the UE 110, a parameter M that indicates a quantity of part or all TBs scheduled in one DCI, and the HARQ feedback for these M TBs can be dynamically enabled or disabled. The base station 120 may determine the parameter M based on a variety of factors, such as the capability of the UE 110, the load at the base station. Thus the value of M may be less than or equal to the number of the TBs (hereinafter referring to as N_TB). For instance, if total 8 TBs can be scheduled in one DCI, the M may be 3,5, or any other value. If M equals to N_TB, all HARQ processes can be dynamically configured with feedback enabled or disabled. If M is less than N_TB, only some of the HARQ processes can be dynamically configured with feedback enabled or disabled, and other scheduled HARQ processes may not be dynamically configured.

At an operation 320, according to the status of the buffer, the base station 120 may decide to map the content of the buffer (e.g., data or control signaling) to multiple TBs, e.g., when the buffer content exceeds a certain threshold. As discussed above with reference to FIGS. 2A and 2B, these multiple TBs may be scheduled in one DCI. Accordingly, the HARQ processes for these multiple TBs may also be scheduled in one DCI.

Then, at an operation 330, the base station 120 may further decide whether to enable or disable the HARQ feedback for one or more HARQ processes of the respective transport blocks. In an example, if a transport block contains data or control signaling (e.g., RRC or MAC CE signaling) that requires a high level of reliability or latency, the base station 120 may determine to enable the HARQ feedback for such transport block. In addition, the base station 120 may determine to disable the HARQ feedback for other transport blocks, so as to avoid the HARQ stalling and increase the throughput. Thus, differentiating the feedback enabling/disabling for the multiple TBs scheduled by one DCI can be adaptive to the requirement level on HARQ feedback and improve the system efficiency.

In an example, if the parameter M is configured in the operation 310, the base station 120 may determine m (m≥0) HARQ process(es) out of M HARQ processes to be feedback enabled or disabled. Otherwise, the base station 120 may determine m (m≥0) HARQ process(es) out of N_TB (i.e., the number of the multiple transport blocks scheduled by one DCI) processes to be feedback enabled or disabled.

Based on the determination made at operation 330, the base station 120 may then transmit, at an operation 340, e.g., by using one DCI, information to indicate that m HARQ process(es) are configured as feedback enabled or disabled for the multiple transport blocks scheduled by a single message. The DCI may be transmitted via, for example, a physical downlink control channel (PDCCH) in an NR NTN system, or an MTC PDCCH (MPDCCH), a narrowband PDCCH (NPDCCH) in an IoT NTN system, or the like.

In order to inform the UE 110 of which HARQ processes for the multiple transport blocks are configured as feedback enabled or disabled, the base station 120 may use at least one bit (e.g., 1 or 2 bits) in the DCI message, or at least one state of a field in the DCI, to indicate the corresponding transport blocks for which HARQ feedback is enabled or disabled.

In an example embodiment, the information may indicate that each of the M or N TB HARQ processes is configured as feedback enabled or disabled simultaneously. For example, when the base station 110 only supports that all the HARQ processes corresponding to the N_TB transport blocks are configured with HARQ feedback enabled or all the HARQ processes corresponding to the N_TB transport blocks are configured with HARQ feedback disabled, the base station 120 may indicate the information with a one-bit indication, e.g., a bit value of “0” may indicate all the HARQ processes are disabled, while a bit value of “1” may indicate all the HARQ processes are enabled.

In an example embodiment, the information may indicate a ratio for determining first or last HARQ processes of the M or N_TB HARQ processes as the m HARQ processes. The ratio may be represented as P/Q, where P, Q are integers (P≤Q). By way of example, P/Q may be 2/2, 1/2, or 0/2, which value may be indicated with a two-bit indication. When 4 TBs are scheduled by one DCI, the base station 120 may use the above threes values to indicate all HARQ processes, the first or last 2 HARQ processes, or 0 HARQ processes are configured with feedback enabled, respectively. Meanwhile, other HARQ processes, if any, may be regarded as being configured with feedback disabled.

It shall be understood that the ratio (P/Q) could take other values. In an example, a floor or ceiling operation may be used to determine the m first or last HARQ processes, e.g., m=floor ((P/Q)*N_TB), or m=ceiling ((P/Q)*N_TB).

In an example embodiment, the information may indicate the first or last HARQ processes of the M or N_TB HARQ processes as the m HARQ processes. For example, when 6 TBs are scheduled by one DCI, the base station 120 may indicate the first or last 0, 1, 2, 3 . . . or 6 HARQ processes as feedback enabled. The remaining other HARQ processes, if any, may be regarded as being configured with feedback disabled.

In an example embodiment, the information may indicate a pattern for determining the m HARQ processes. For example, the base station 120 may configure multiple patterns for one or more HARQ processes of the multiple HARQ processes scheduled by one DCI. As an illustration, patterns (1100, 1010, 1110) may be configured for a case where 4 HARQ processes are scheduled by one DCI. Each pattern may be associated with a pattern index such that a limited bit may indicate more options. The mapping between the multiple patterns and respective pattern index can be configured via an RRC message. With such configuration, at the operation 340, the base station 120 may include the pattern index in the DCI to indicate which pattern is to be used. For instance, with pattern “1100”, the base station 120 would inform the UE 110 that first 2 HARQ processes will be configured with feedback enabled, and other HARQ processes are configured with feedback disabled. It shall be noted that the above depiction is merely for illustrative purposes and not limiting in any way. The pattern may also be represented in other form so long as it can indicate one or more HARQ processes are configured as feedback enabled or disabled.

At an operation 350, the base station 120 may further transmit, to the UE 110, the multiple TBs scheduled by one DCI, after the DCI transmission is completed.

In response to receiving the DCI and downlink transmission scheduled by the DCI, at an operation 360, the UE 110 may decode the transport blocks associated to the HARQ process based on the received information. Further, the UE 110 may determine whether to enable or disable HARQ feedback for one or more HARQ processes associated with the multiple TBs based on the received information on enabling/disabling of HARQ feedback. If a HARQ process is configured as feedback enabled, the UE 110 may determine to generate an ACK or NACK signal for the corresponding transport block. Meanwhile, if a HARQ process is configured as feedback disabled, the UE 110 may determine not to generate a feedback signal for the corresponding transport block.

As discussed above, the UE 110 may have received configuration information on the enabling/disabling of feedback for HARQ process, e.g., at operation 310. In this case, the new information received at operation 340 may override at least part of previous configuration of HARQ process for the multiple transport blocks. As an illustration, the base station 120 may schedule 4 HARQ processes in one DCI, and initially configure HARQ process #0, #1 as feedback enabled, and HARQ process #2, #3 as feedback disabled, e.g., via an RRC signaling. In case where M is less than N_TB, for example, the received DCI at operation 340 indicates dynamically only HARQ processes #0, #1, #2 are configured as feedback enabled or disabled, the UE 110 would learn that the new configuration overrides the previous configuration with respect to HARQ processes #0, #1, #2, and the feedback for HARQ process #3 would still be configured as disabled.

In an example embodiment, the override may be a temporary override, e.g., the dynamic enabling/disabling of HARQ feedback may be only for initial transmission from the base station 120 to the UE 110. Alternatively, the override may be a permanent override and apply for all future HARQ processes.

When it is determined that, based on the received information, one or more HARQ processes are configured as feedback enabled, at an operation 370, the UE may transmit feedback for the HARQ processes. If a transport block corresponding to the HARQ process is received, the UE 110 may transmit an ACK signal, otherwise the UE 110 may transmit a NACK signal, to the base station 120.

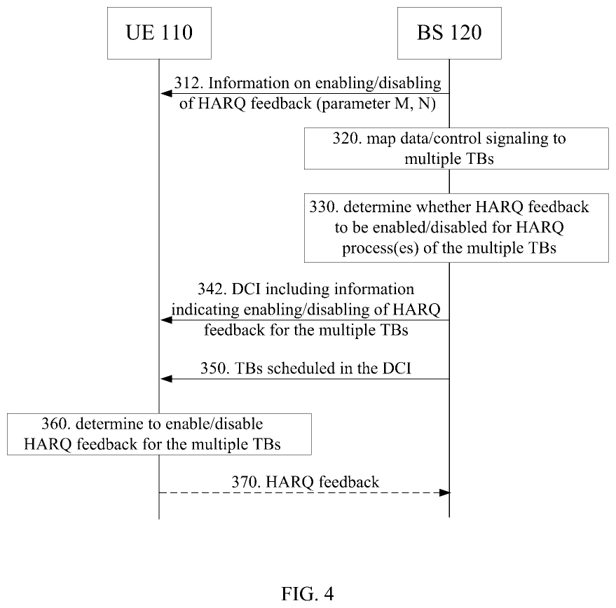

FIG. 4 is a message flow diagram illustrating a process for enabling or disabling feedback for HARQ processes according to an example embodiment of the present disclosure. The process shown in FIG. 4 may be performed by, for example, the UE 110 and the base station 120. Details which have been described with respect to the FIG. 3 are briefly described or omitted.

Referring to FIG. 4, the base station 120 may transmit, at an operation 312, configuration information on enabling/disabling of HARQ feedback to the UE 110, e.g., via an RRC message. The configuration may be used as a default configuration to indicate whether HARQ feedback is to be enabled or disabled for future downlink transmission, or which one or more HARQ processes for multiple transport blocks (TBs) are configured as HARQ feedback enabled or disabled.

In an example, the base station 120 may configure, for the UE 110, a parameter M that indicates a quantity of part or all TBs scheduled in one DCI, and the HARQ feedback for these M TBs can be dynamically enabled or disabled. The value of M may be less than or equal to the number of the TBs scheduled in one DCI (i.e. N_TB). For instance, if total 8 TBs can be scheduled in one DCI, then M may be 3, 5, or any other value.

In addition, the base station 120 may configure a parameter N that indicates, for N_TB transport blocks, HARQ processes of maximum N transport blocks will be able to be dynamically enabled or disabled. The base station 120 may determine the parameter N based on a variety of factors, such as the traffic of data and possible signaling, and their QoS requirement, etc. By way of example, the base station 120 may consider how many TBs will be needed for carrying the control signaling when determining the value of N. In an example, the value of N may be less than or equal to the value of M. For instance, if M is 5, N may be determined to be 2, 3, or any other value. The function of the parameters M, N will be descried in more detail later.

At an operation 320, according to the status of the buffer, the base station 120 may decide to map the content of the buffer, such as the data or control signaling, to multiple TBs, which may be scheduled in one DCI.

Then, at an operation 330, the base station 120 may further decide whether to enable or disable the HARQ feedback for one or more HARQ processes of the respective transport blocks. In an example, if the value of N is larger than 0, the base station 120 may determine to enable the HARQ feedback for one or more transport blocks, as these transport blocks may contain data or control signaling that requires a high level of reliability or latency. Then, the base station 120 may determine m (e.g., m≤N) HARQ process(es) to be feedback enabled or disabled.

Based on the determination made at operation 330, the base station 120 may, at an operation 342, transmit information to indicate that m HARQ process(es) are configured as feedback enabled or disabled for the multiple transport blocks scheduled by one DCI.

As the base station 120 has informed the UE 110 of the value of N, the information on the m HARQ process(es) can be indicated in a more efficient and adaptive way. For example, the base station may compare the value of N with M and then decide how to enable or disable feedback for the m HARQ process(es).

In an example embodiment, when the number N means that HARQ processes of maximum N transport blocks are able to be dynamically enabled, and if N≤M/2, the base station 120 may configure and indicate m (e.g., m=N) HARQ processes as feedback enabled, with other (M−m) HARQ processes being regarded as feedback disabled. Otherwise, if N>M/2, the base station 120 may indicate m (e.g., m=M−N) HARQ processes are configured as feedback disabled, with other (M−m) processes being regarded as feedback enabled.

In an example embodiment, when the number N means that HARQ processes of maximum N transport blocks are able to be dynamically disabled, and if N≤M/2, the base station 120 may indicate m (e.g., m=N) HARQ processes as feedback disabled, with other (M−m) processes being regarded as feedback enabled. Otherwise, if N>M/2, the base station 120 may indicate m (e.g., m=M−N) HARQ processes as feedback enabled, with other (M−m) HARQ processes being regarded as feedback disabled.

In order to inform the UE 110 of which HARQ processes for the multiple transport blocks are configured as feedback enabled or disabled, the base station 120 may use at least one bit (e.g., 1 or 2 bits) in the DCI message, or at least one state of a field in the DCI, to indicate the corresponding transport blocks for which HARQ feedback is enabled or disabled.

In an example embodiment, the base station 110 may only support that all the HARQ processes are configured with HARQ feedback enabled or disabled. In this case, the base station 120 may indicate that N takes the value of 0 or M at the operation 312. Then, according to the aforementioned rules, the base station 120 may indicate, at the operation 342, by using a one-bit indication, that 0 HARQ process are configured with feedback enabled or disabled, i.e., all HARQ processes are configured as feedback disabled or enabled simultaneously.

In an example embodiment, the information may indicate a ratio for determining first or last HARQ processes of the M HARQ processes as the m HARQ processes. The ratio may be represented as P/Q and have a value of less than or equal to 1/2, where P, Q are integers (PSQ). By way of example, P/Q may be 0/4, 1/4, or 2/4, which value may be indicated with a two-bit indication. When 4 TBs are scheduled by one DCI, the base station 120 may use the above threes values to indicate 0 HARQ processes, the first or last 1 HARQ processes, or the first or last 2 HARQ processes with feedback enabled, respectively. Meanwhile, other HARQ processes, if any, may be regarded as being configured with feedback disabled.

It shall be understood that the ratio (P/Q) could take other values. In an example, a floor or ceiling operation may be used to determine the m first or last HARQ processes, i.e., m=floor ((P/Q)*M), or m=ceiling ((P/Q)*M).

In an example embodiment, the information may indicate the first or last HARQ processes of the M HARQ processes as the m HARQ processes. For example, when 8 TBs are scheduled by one DCI, the base station 120 may indicate the first or last 0, 1, 2, 3, or 4 HARQ processes as feedback enabled. The remaining other HARQ processes, if any, may be regarded as being configured with feedback disabled.

In an example embodiment, the information may indicate a pattern for determining the m HARQ processes. For example, the base station 120 may configure multiple patterns for one or more HARQ processes of the multiple HARQ processes scheduled by one DCI. As an illustration, patterns (1100, 1010,1110) may be configured for a case where 6 or 8 HARQ processes are scheduled by one DCI. Each pattern may be associated with a pattern index such that a limited bit may indicate more options. The mapping between the multiple patterns and respective pattern index can be configured via an RRC message. With such configuration, at the operation 342, the base station 120 may include the pattern index in the DCI to indicate which pattern is to be used. For instance, with pattern “1100”, the base station 120 would inform the UE 110 that first 2 HARQ processes will be configured with feedback enabled, and other HARQ processes are regarded as being configured with feedback disabled. It shall be noted that the above depiction is merely for illustrative purposes and not limiting in any way. The pattern may also be represented in other form so long as it can indicate one or more HARQ processes are configured as feedback enabled or disabled.

At an operation 350, the base station 120 may further transmit, to the UE 110, the multiple TBs scheduled by one DCI, after the DCI transmission is completed.

In response to receiving the DCI and downlink transmission scheduled by the DCI, at an operation 360, the UE 110 may decode the transport blocks associated to the HARQ process based on the received information. Further, the UE 110 may determine to enable or disable feedback for the m HARQ processes, and disable or enable feedback for the other (M−m) HARQ processes based on the received information on enabling/disabling of HARQ feedback.

In an example, the new information received at operation 342 may override at least part of previous configuration of HARQ process for the multiple transport blocks. As an illustration, the base station 120 may schedule 4 HARQ processes in one DCI, and initially configure HARQ process #0 as feedback enabled, and HARQ process #1, #2, #3 as feedback disabled, e.g., via an RRC signaling. In case where M is equal to N_TB, for example, the received DCI at operation 342 indicates dynamically that HARQ processes #0, #1 are configured as feedback enabled, the UE 110 would learn that the new configuration overrides the previous configuration. According to the aforementioned rules, HARQ processes #0, #1 are configured as feedback enabled, and the feedback for HARQ process #2, #3 would be regarded as disabled.

When it is determined that, based on the received information, one or more HARQ processes are configured as feedback enabled, at an operation 370, the UE may transmit feedback, e.g., an ACK or NACK signal, for the HARQ processes.

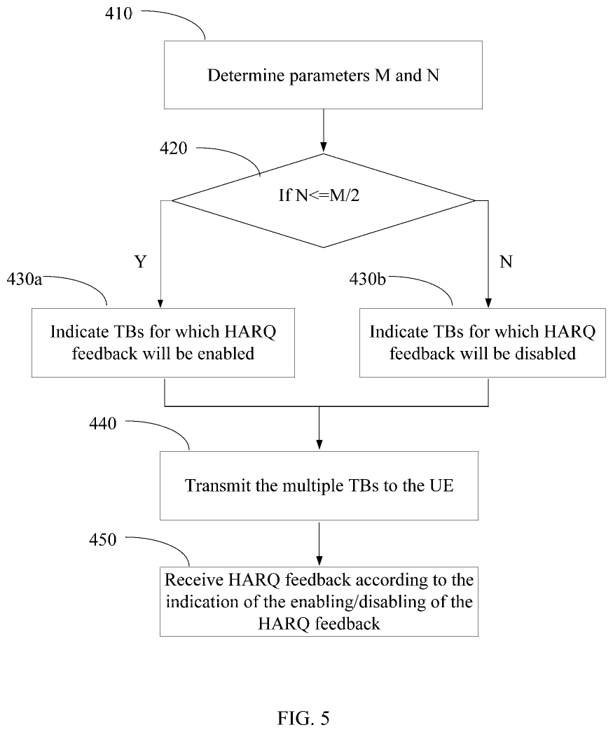

In order to better illustrate some aspects of the present disclosure, the following embodiments will be described with reference to FIG. 5. As shown, a method performed by e.g., base station 120, for dynamically enabling or disabling feedback for one or more HARQ processes may include the following steps.

In step 410, the base station 120 may determine a number M of transport blocks scheduled in one DCI for which the HARQ feedback can be dynamically enabled or disabled. As discussed above, M may be less than or equal to the total number of TBs scheduled in one DCI, i.e., N_TB. In addition, the base station 120 may determine a number N of TBs that may need HARQ feedback for the N TB transport blocks, based on the traffic of data and possible signaling.

In an example, the parameters M and N may be sent to the UE 110 by a high layer signaling (e.g., RRC signaling), so that the UE 110 would follow the same rule as the base station 120.

In step 420, the base station 120 compares the value N with the value M/2. If N is less than or equal to M/2, then in step 430a, the base station 120 may indicate the transport block(s) for which HARQ feedback will be enabled. On the other hand, if N is larger than M/2, then in step 430b, the base station 120 may indicate the transport block(s) for which HARQ feedback will be disabled.

Taking 4 TBs scheduled in one DCI for example. If N is 0, 1, or 2, the base station 120 may indicate the HARQ processes for which HARQ feedback will be enabled, with other HARQ processes being regarded as feedback disabled. If N is 3, or 4, the base station 120 may indicate the HARQ processes for which HARQ feedback will be disabled, with other HARQ processes being regarded as feedback enabled. Various ways to indicate the HARQ processes have been discussed with reference to FIGS. 3 and 4, and a repetitive description thereof is omitted here.

For the 4 TBs scheduled in one DCI, generally it will need 5 different statuses to indicate the possible number of transport block for which HARQ feedback is enabled or disabled. In contrast, according to the example embodiment of the present disclosure, the maximum statuses needed in DCI will be 3 or 2. Therefore, an advantage of the example embodiment is that it may reduce the maximum statuses needed in the DCI, and thus improve the efficiency of the DCI.

In step 440, the base station 120 may transmit, via e.g., PDSCH or NPDSCH, the multiple TBs scheduled by one DCI to the UE 110. Then, in step 450, the base station 120 may receive HARQ feedback, e.g., an ACK or NACK signal, for the multiple TBs.

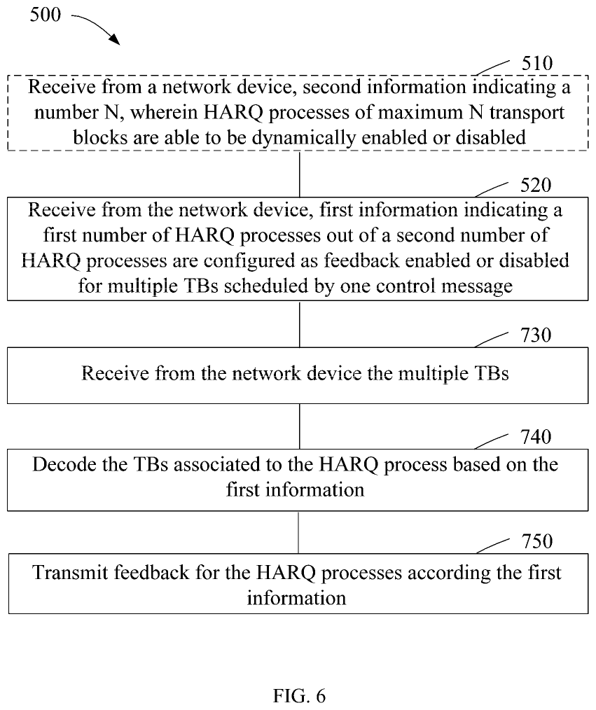

FIG. 6 shows a flowchart of an example method 500 for HARQ feedback enabling/disabling according to an example embodiment of the present disclosure. The method 500 can be implemented at a terminal device e.g. the UE 110 discussed above. It would be understood that step illustrated in dashed-line block represent an optional step and can be omitted in some example embodiments. In some example embodiments, the method 500 may further include one or more steps that are performed at the UE 110 as described above with respect to FIGS. 3-4. It would also be understood that details of some steps in the procedure 500 have been discussed above with respect to FIGS. 3-4 and the procedure 500 will be described here in a simple manner.

At block 510, the terminal device may receive from a network device, second information indicating a third number N, wherein HARQ processes of maximum N transport blocks are able to be dynamically enabled or disabled.

At block 520, the terminal device may receive from the network device, first information indicating a first number of HARQ processes out of a second number of HARQ processes are configured as feedback enabled or disabled for multiple transport blocks scheduled by one control message. The second number may be less than or equal to the number of the multiple transport blocks.

In some example embodiments, the first information may include at least one bit or at least one state to indicate at least one of the following: each of the second number of HARQ processes is configured as feedback enable or disabled simultaneously; a ratio for determining first or last HARQ processes of the second number of HARQ processes corresponding to the first number of HARQ processes; the first or last HARQ processes of the second number of HARQ processes corresponding to the first number of HARQ processes; or a pattern for determining the first number of HARQ processes.

In some example embodiments, the first information may override at least part of previous configuration of HARQ process for the multiple transport blocks.

In some example embodiments, in case where N is less than or equal to half of the second number, the first number of HARQ processes may be configured as feedback enabled, and/or, in case where N is more than half of the second number, the first number of HARQ processes may be configured as feedback disabled.

At block 530, the terminal device may receive from the network device, the multiple transport blocks.

At block 540, the terminal device may decode the transport blocks associated to the HARQ process based at least on the first information.

At block 550, the terminal device may transmit feedback for the HARQ processes according the first information.

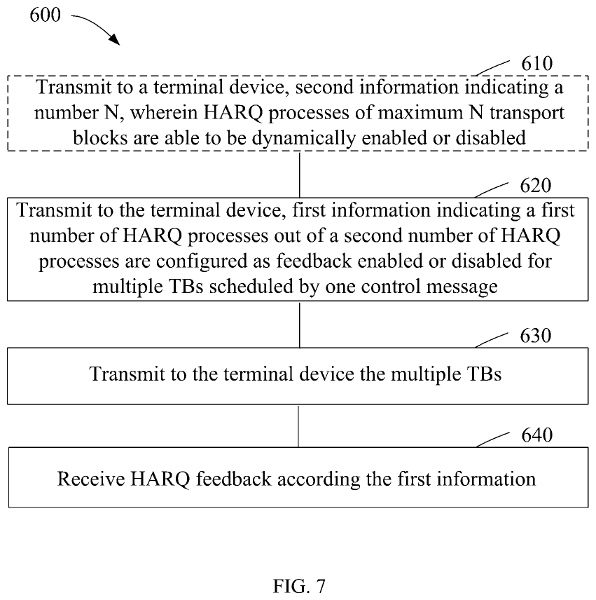

FIG. 7 shows a flowchart of an example method 600 for HARQ feedback enabling/disabling according to an example embodiment of the present disclosure. The method 600 may be performed at a base station like the base station 120 discussed above. In some example embodiments, the method 600 may further include one or more steps that are performed at the base station 120 as described above with respect to FIGS. 3-5. It would also be understood that details of some steps in the procedure 600 have been discussed above with respect to FIGS. 3-5 and the procedure 600 will be described here in a simple manner.

At block 610, the network device may transmit to a network device, second information indicating a third number N, wherein HARQ processes of maximum N transport blocks are able to be dynamically enabled or disabled.

At block 620, the network device may transmit to the network device, first information indicating a first number of HARQ processes out of a second number of HARQ processes are configured as feedback enabled or disabled for multiple transport blocks scheduled by one control message. The second number may be less than or equal to the number of the multiple transport blocks.

At block 630, the network device may transmit to the terminal device, the multiple transport blocks.

At block 640, the network device may receive feedback for the HARQ processes according to the first information.

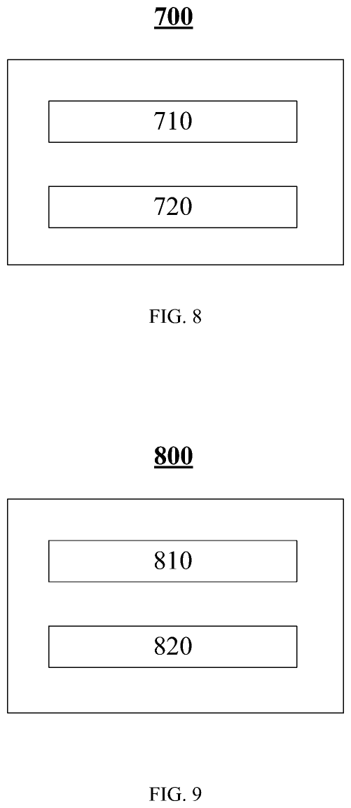

FIG. 8 is a block diagram illustrating an apparatus 700 according to an example embodiment of the present disclosure. The apparatus 1100 may be implemented at a terminal device like the UE 110 to perform operations relating to the UE 110 as discussed above. Since the operations relating to the UE 110 have been discussed in detail with reference to FIGS. 3-4, the blocks of the apparatus 700 will be described briefly here and details thereof may refer to the above description.

Referring to FIG. 8, the apparatus 700 may include a first means 710 for receiving from a network device, first information indicating a first number of HARQ processes out of a second number of HARQ processes are configured as feedback enabled or disabled for multiple transport blocks scheduled by one control message, and a second means 720 for receiving from the network device, the multiple transport blocks. The second number may be less than or equal to the number of the multiple transport blocks

In some example embodiments, the apparatus 700 may further include a third means for receiving from the network device, second information indicating a third number N, wherein HARQ processes of maximum N transport blocks are able to be dynamically enabled or disabled.

In some example embodiments, the apparatus 1100 may further include a fourth means for decoding the transport blocks associated to the HARQ process based at least on the first information.

In some example embodiments, the apparatus 1100 may further include a fifth means for transmitting feedback for the HARQ processes according the first information.

FIG. 9 is a block diagram illustrating an apparatus 800 according to an example embodiment of the present disclosure. The apparatus 800 may be implemented to comprise or to form at least part of the base station 120 discussed above to perform at least part of operations related to the base station 120. Since the operations related to the base station 120 have been discussed above with reference to FIGS. 3-5, the blocks of the apparatus 800 will be described briefly here and details thereof may refer to the above description.

Referring to FIG. 9, the apparatus 800 may include a first means 810 for transmitting to a terminal device, first information indicating a first number of HARQ processes out of a second number of HARQ processes are configured as feedback enabled or disabled for multiple transport blocks scheduled by one control message, and a second means 820 for transmitting to the terminal device, the multiple transport blocks. The second number may be less than or equal to the number of the multiple transport blocks.

In some example embodiments, the apparatus 800 may further include a third means for transmitting to the terminal device, second information indicating a third number N, wherein HARQ processes of maximum N transport blocks are able to be dynamically enabled or disabled.

In some example embodiments, the apparatus 800 may further include a fourth means for receiving feedback for the HARQ processes according to the first information.

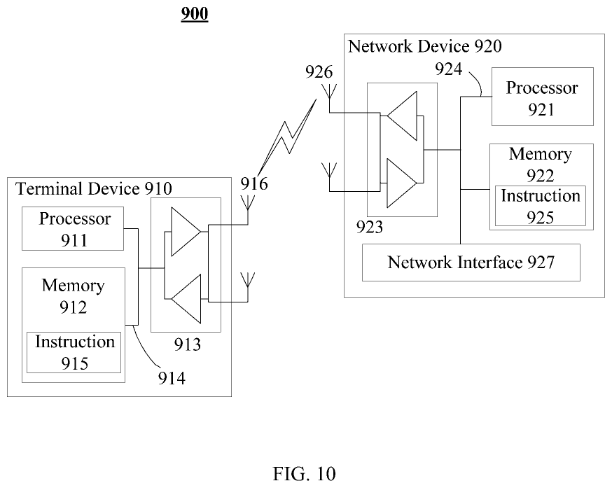

FIG. 10 is a block diagram illustrating devices in a communication system 900 in accordance with an example embodiment of the present disclosure. As shown in FIG. 10, the communication system 900 may comprise a terminal device 910 which may be implemented as the UE 110 discussed above and a network device 920 which may be implemented as the base station 120 discussed above.

Referring to FIG. 10, the terminal device 910 may comprise one or more processors 911, one or more memories 912 and one or more transceivers 913 interconnected through one or more buses 914. The one or more buses 914 may be address, data, or control buses, and may include any interconnection mechanism such as series of lines on a motherboard or integrated circuit, fiber, optics or other optical communication equipment, and the like. Each of the one or more transceivers 913 may comprise a receiver and a transmitter, which are connected to one or more antennas 916. The terminal device 910 may wirelessly communicate with the radio access network device 920 through the one or more antennas 916. The one or more memories 912 may include instructions 915 which, when executed by the one or more processors 911, may cause the terminal device 910 to perform operations and procedures relating to the UE 110 as described above.

The network device 920 may comprise one or more processors 921, one or more memories 922, one or more transceivers 923 and one or more network interfaces 927 interconnected through one or more buses 924. The one or more buses 924 may be address, data, or control buses, and may include any interconnection mechanism such as a series of lines on a motherboard or integrated circuit, fiber, optics or other optical communication equipment, and the like. Each of the one or more transceivers 923 may comprise a receiver and a transmitter, which are connected to one or more antennas 926. The network device 920 may operate as a base station for the terminal device 910 and wirelessly communicate with terminal device 910 through the one or more antennas 926. The one or more network interfaces 927 may provide wired or wireless communication links through which the network device 920 may communicate with other network devices, entities, elements or functions. For example, the network device 920 may communicate with a core network device (not shown) via backhaul connections. The one or more memories 922 may include instructions 925 which, when executed by the one or more processors 921, may cause the network device 920 to perform operations and procedures relating to the base station 120.

The one or more processors 911, 921 discussed above may be of any appropriate type that is suitable for the local technical network, and may include one or more of general purpose processors, special purpose processor, microprocessors, a digital signal processor (DSP), one or more processors in a processor based multi-core processor architecture, as well as dedicated processors such as those developed based on Field Programmable Gate Array (FPGA) and Application Specific Integrated Circuit (ASIC). The one or more processors 911, 921 may be configured to control other elements of the UE/radio access network device/core network device and operate in cooperation with them to implement the procedures discussed above.

The one or more memories 912, 922 may include at least one storage medium in various forms, such as a transitory memory and/or a non-transitory memory. The transitory memory may include, but not limited to, for example, a random access memory (RAM) or a cache. The non-transitory memory may include, but not limited to, for example, a read only memory (ROM), a hard disk, a flash memory, and the like. The term “non-transitory,” as used herein, is a limitation of the medium itself (i.e., tangible, not a signal) as opposed to a limitation on data storage persistency (e.g., RAM vs. ROM). Further, the one or more memories 912, 922 may include but not limited to an electric, a magnetic, an optical, an electromagnetic, an infrared, or a semiconductor system, apparatus, or device or any combination of the above.

It would be understood that blocks in the drawings may be implemented in various manners, including software, hardware, firmware, or any combination thereof. In some embodiments, one or more blocks may be implemented using software and/or firmware, for example, machine-executable instructions stored in the storage medium. In addition to or instead of machine-executable instructions, parts or all of the blocks in the drawings may be implemented, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-Chip systems (SOCs), Complex Programmable Logic Devices (CPLDs), etc.

Some exemplary embodiments further provide program instruction or instructions which, when executed by one or more processors, may cause a device or apparatus to perform the procedures described above. The program instruction for carrying out procedures of the exemplary embodiments may be written in any combination of one or more programming languages. The program instruction may be provided to one or more processors or controllers of a general purpose computer, special purpose computer, or other programmable data processing apparatus, such that the program instruction, when executed by the processor or controller, cause the functions/operations specified in the flowcharts and/or block diagrams to be implemented. The program instruction may execute entirely on a machine, partly on the machine, as a stand-alone software package, partly on the machine and partly on a remote machine or entirely on the remote machine or server.

Some exemplary embodiments further provide a computer program product or a computer readable medium having the program instruction or instructions stored therein. The computer readable medium may be any tangible medium that may contain, or store a program for use by or in connection with an instruction execution system, apparatus, or device. The machine readable medium may be a machine readable signal medium or a machine readable storage medium. A machine readable medium may include but is not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in a language that is specific to structural features and/or method actions, it is to be understood the subject matter defined in the appended claims is not limited to the specific features or actions described above. On the contrary, the above-described specific features and actions are disclosed as an example of implementing the claims. This listing of claims will replace all prior versions, and listings, of claims in the application:

1. A terminal device, comprising:
at least one processor; and
at least one memory storing instructions that, when executed by the at least one processor, cause the terminal device at least to:
receive from a network device, first information indicating a first number of hybrid automatic repeat request (HARQ) processes out of a second number of HARQ processes are configured as feedback enabled or disabled for multiple transport blocks scheduled by one control message, the second number being less than or equal to the number of the multiple transport blocks; and
receive from the network device, the multiple transport blocks.

2. The terminal device of claim 1, wherein the first information includes at least one bit or at least one state to indicate at least one of the following:
each of the second number of HARQ processes is configured as feedback enable or disabled simultaneously;
a ratio for determining first or last HARQ processes of the second number of HARQ processes corresponding to the first number of HARQ processes;
the first or last HARQ processes of the second number of HARQ processes corresponding to the first number of HARQ processes; or
a pattern for determining the first number of HARQ processes.

3. The terminal device of claim 1, wherein the first information overrides at least part of previous configuration of HARQ process for the multiple transport blocks.

4. The terminal device of claim 1, wherein the at least one memory further stores instructions that, when executed by the at least one processor, cause the terminal device at least to:
receive from the network device, second information indicating a third number N, wherein HARQ processes of maximum N transport blocks are able to be dynamically enabled,
and wherein if N is less than or equal to half of the second number, the first number of HARQ processes are configured as feedback enabled, and/or, if N is more than half of the second number, the first number of HARQ processes are configured as feedback disabled.

5. The terminal device of claim 1, wherein the at least one memory further stores instructions that, when executed by the at least one processor, cause the terminal device at least to:
receive from the network device, second information indicating a third number N, wherein HARQ processes of maximum N transport blocks are able to be dynamically disabled,
and wherein if N is less than or equal to half of the second number, the first number of HARQ processes are configured as feedback disabled, and/or, if N is more than half of the second number, the first number of HARQ processes are configured as feedback enabled.

6. The terminal device of claim 1, wherein the second information is received via a radio resource control (RRC) message.

7. The terminal device of claim 1, wherein the first information is received via a downlink control information (DCI) message.

8. The terminal device of claim 1, wherein the at least one memory further stores instructions that, when executed by the at least one processor, cause the terminal device at least to:
decode the transport blocks associated to the HARQ process based at least on the first information.

9. The terminal device of claim 1, wherein the at least one memory further stores instructions that, when executed by the at least one processor, cause the terminal device at least to:
transmit feedback for the HARQ processes according the first information.

10. A network device, comprising:
at least one processor; and
at least one memory storing instructions that, when executed by the at least one processor, cause the network device at least to:
transmit to a terminal device, first information indicating a first number of hybrid automatic repeat request (HARQ) processes out of a second number of HARQ processes are configured as feedback enabled or disabled for multiple transport blocks scheduled by one control message, the second number being less than or equal to the number of the multiple transport blocks; and
transmit to the terminal device, the multiple transport blocks.

11. The network device of claim 10, wherein the first information includes at least one bit or at least one state to indicate at least one of the following:
each of the second number of HARQ processes is configured as feedback enable or disabled simultaneously;
a ratio for determining first or last HARQ processes of the second number of HARQ processes corresponding to the first number of HARQ processes;
the first or last HARQ processes of the second number of HARQ processes corresponding to the first number of HARQ processes; or
a pattern for determining the first number of HARQ processes.

12. The network device of claim 10, wherein the first information overrides at least part of previous configuration of HARQ process for the multiple transport blocks.

13. The network device of claim 10, wherein the at least one memory further stores instructions that, when executed by the at least one processor, cause the network device at least to:
transmit to the terminal device, second information indicating a third number N, wherein HARQ processes of maximum N transport blocks are able to be dynamically enabled,
and wherein if N is less than or equal to half of the second number, the first number of HARQ processes are configured as feedback enabled, and/or, if N is more than half of the second number, the first number of HARQ processes are configured as feedback disabled.

14. The network device of claim 10, wherein the at least one memory further stores instructions that, when executed by the at least one processor, cause the network device at least to:
transmit to the terminal device, second information indicating a third number N, wherein HARQ processes of maximum N transport blocks are able to be dynamically disabled,
and wherein if N is less than or equal to half of the second number, the first number of HARQ processes are configured as feedback disabled, and/or, if N is more than half of the second number, the first number of HARQ processes are configured as feedback enabled.

15. The network device of claim 10, wherein the second information is received via a radio resource control (RRC) message.

16. The network device of claim 10, wherein the first information is received via a downlink control information (DCI) message.

17. The network device of claim 10, wherein the at least one memory further stores instructions that, when executed by the at least one processor, cause the network device at least to:
receive feedback for the HARQ processes according to the first information.

18. A method comprising:
receiving from a network device, first information indicating a first number of hybrid automatic repeat request (HARQ) processes out of a second number of HARQ processes are configured as feedback enabled or disabled for multiple transport blocks scheduled by one control message, the second number being less than or equal to the number of the multiple transport blocks; and
receiving from the network device, the multiple transport blocks.

19. The method of claim 18, wherein the first information includes at least one bit or at least one state to indicate at least one of the following:
each of the second number of HARQ processes is configured as feedback enable or disabled simultaneously;
a ratio for determining first or last HARQ processes of the second number of HARQ processes corresponding to the first number of HARQ processes;
the first or last HARQ processes of the second number of HARQ processes corresponding to the first number of HARQ processes; or
a pattern for determining the first number of HARQ processes.

20. The method of claim 18, wherein the first information overrides at least part of previous configuration of HARQ process for the multiple transport blocks.

21-38. (canceled)
